(19) United States
(12) Patent Application Publication
(10) Pub. No.: US 2013/0299394 A1
(43) Pub. Date: Nov. 14, 2013

(54) METHOD AND APPARATUS FOR FROTH FLOTATION CONTROL

(71) Applicant: Johannes Jacobus Le Roux Cilliers, Palmers Green (GB)

(72) Inventor: Johannes Jacobus Le Roux Cilliers, Palmers Green (GB)

(21) Appl. No.: 13/988,181

(22) PCT Filed: Nov. 18, 2011
(86) PCT No.: PCT/GB2011/052263

§ 371 Date: Aug. 1, 2013

(30) Foreign Application Priority Data
Nov. 19, 2010 (GB) 1019677.2

(51) Int. Cl. B03D 1/02

(52) U.S. Cl. CPC B03D 1/028
USPC 209/164; 209/168

(57) ABSTRACT

The invention provides a method of controlling operation of a froth flotation cell, the method comprising: introducing gas into a liquid in the cell, thereby to create a froth on the surface of the liquid, the froth having a depth from the surface of the liquid to an overflow point at which the froth overflows and leaves the cell; and controlling the froth depth to optimise the gas recovery with respect to the froth depth. Optimisation of the gas recovery with respect to the froth depth leads to the recovery of a froth concentrate of both high grade and high product recovery.

This invention relates to a method and apparatus of controlling one or more froth flotation cells for separating substances.

Froth flotation is a method of performing a separation that is used in various different industries. For example, froth flotation is used to separate different minerals in an ore, or for de-inking paper or for cleaning coal.

The present invention, and the background thereto, is discussed primarily with reference to the separation of minerals in an ore, but the invention is not limited to this particular use of froth flotation. The invention is applicable to all froth flotation processes.

Mineral froth flotation is a known industrial process used for extracting valuable mineral content from ore obtained for example through mining. It is a surface chemistry process used to separate solids, typically fine solids, by exploiting the variation in hydrophilicity between different materials.

A flotation cell or vessel, contains a pulp of matter such as ore from which the mineral is to be extracted mixed with liquid. Gas is flowed through the pulp and separation is achieved by the selective adherence of hydrophobic particles to gas bubbles whilst any hydrophilic particles remain in the liquid which flows between the gas bubbles in the vessel. When bubbles rise to the top of the vessel a froth is formed.

The froth extends from the pulp-froth interface to a bursting surface, which is typically above the overflow lip. A “froth depth” is defined as the distance between the pulp-froth interface and the overflow lip. A “froth height” is defined as the distance from the overflow lip to the bursting surface.

The froth can be arranged to overflow from the flotation vessel with both hydrophobic and hydrophilic particles comprised therein. Those particles can be extracted as a concentrate. Typically, in mineral froth flotation, it is the hydrophobic particles which are the desired product, and are intended to be recovered from the froth.

The remaining pulp in the flotation vessel is commonly referred to as the tailings. In some froth flotation processes (such as the de-inking of paper) it is the remaining pulp in the flotation vessel that is the desired product.

In practice a froth flotation plant will contain multiple cells, typically arranged in banks of similar type, where material is fed through the bank, cell by cell, and then on to the next bank. Cell types may differ between banks, the initial bank, for example, containing “roughers” which are used for initial crude separation of desired matter from undesired matter. Downstream, banks may include secondary roughers, also known as “scavengers”, which perform additional separation on the pulp which remains in a rougher after froth has been overflown therefrom. Downstream banks may also include “cleaners”, which perform separation on froth which has been extracted from roughers or scavengers.

The performance quality of a flotation process can be measured with respect to two characteristics of the concentrate that is extracted from the flotation vessel—“grade” and “recovery”. When referring to mineral systems in which the desired product is recovered from the froth, grade indicates the fraction of desired solids in the concentrate as compared to undesired solids (gangue). Recovery indicates the fraction of desired solids in the concentrate as compared to the fraction of desired solids in the original ore feed that was input into the flotation cell. An industrial flotation process is manipulated in order to achieve an optimal balance between grade and recovery, with an ideal flotation process producing high recovery of high grade concentrate.

It is known that several controllable factors can affect the performance quality of a flotation process. These include the pH of the pulp, the concentration of various chemicals added to the flotation vessel, solids concentration and gas flow rate into the flotation vessel. However, the presence of so many variables makes quantitative control of froth flotation processes difficult.

According to known methods of controlling and operating a froth flotation plant, a controller can observe a flotation cell and manually or otherwise adjust the inputs to the cell, for example by adding additional chemicals and/or changing the gas flow rate into the cell, according to his or her observations. Typically these adjustments are empirical, based particularly on observation of the froth surface and its behaviour. However, such methods of adjustment are often imprecise. Furthermore, changes in certain visual aspects of a flotation froth do not correspond necessarily to variation in output performance quality.

In addition, modern industrial processes make use of increasingly large flotation cells. This increase in size tends to encourage the use of increased power and gas volume in flotation cells, regardless of performance considerations, increasing the inefficiency inherent in existing control and operation methods. Problems therefore remain in known practical flotation methods with respect to which variables should be observed, measured and controlled in order to optimise flotation performance, as well as how to manipulate those relevant variables accurately.

A discussion of investigating froth flotation performance is provided in Barbian et al, “The Froth Stability Column—Measuring Froth Stability at an Industrial Scale”, Minerals Engineering, 2006, Vol 19, No. 6-8, 713-718 in which correlations are identified between a froth stability factor, gas rate and froth depth in a single cell. The discussion concludes that metallurgical results indicate that changes in air flow rate result in variations in flotation performance that can be attributed to changes in froth stability, and that their study showed that high froth stability conditions occur at medium air flow rates which in turn result in improved flotation performance.

An earlier paper, “The froth stability column: linking froth stability and flotation performance”, Minerals Engineering, 2005, Vol 18, 317-324, presents results that show that high froth stability conditions occur at lower air flow rates, and result in improved flotation performance.

Another paper, “Simple relationships for predicting the recovery of liquid from flowing foams and froths”, Minerals Engineering, 2003, Vol 16, 1123-1130, is primarily directed to 2-phase systems and states that the amount of water collected is intimately related to the amount of gangue collected, which in turn helps dictate the grade of the product obtained. This paper also teaches that the amount of water collected will be virtually independent of foam depth and that there is no significant change in water recovery with foam height.

WO 2009/044149 discloses a method of froth flotation control in which the flow rate of gas into the cell is varied in order to optimise the fraction of the input gas which is recovered in the froth overflowing the cell (as opposed to gas input into the cell which forms bubbles that subsequently burst and therefore escapes from the cell). Hence, WO 2009/044149 discloses how one variable (the gas flow rate) may be optimised for a froth flotation system. However, as mentioned above, there are many other variables which can affect the performance of a froth flotation system.

In contrast to the prior art presented above, the present invention has identified for the first time that by monitoring and controlling the froth depth itself (as opposed, for example, to the air inlet flow rate), the gas recovery can surprisingly be optimised with respect to the froth depth to produce advantageous operating conditions for a flotation vessel.

According to the present invention there is provided a method of controlling operation of a froth flotation cell, the method comprising: introducing gas into a liquid in the cell, thereby to create a froth on the surface of the liquid, the froth having a depth from the surface of the liquid to an overflow point at which the froth overflows and leaves the cell; and controlling the froth depth to optimise the gas recovery with respect to the froth depth.

The method of the present invention allows for improved performance in a froth flotation cell by making use of the easily monitored variable of the gas recovery. The gas recovery is the ratio of the amount of gas in the froth overflowing the cell, compared to the gas input into the cell. By controlling the froth depth to find the froth depth that gives the maximum gas recovery, a good concentrate grade can be obtained whilst also obtaining a good mineral recovery. In contrast, most prior art methods only optimise either the grade or the mineral recovery. That is, a high grade is sacrificed in order to obtain a high mineral recovery, or vice versa. No single parameter is identified which can be optimised to provide both high grades and high mineral recovery. In the invention, the control of the froth depth allows the identification of a peak value of gas recovery, and the operation of the cell is optimised to work in the vicinity of this peak value for the given conditions (i.e. the gas recovery is optimised with respect to the froth depth).

In one embodiment, the froth depth is controlled by changing the volume of liquid in the cell. When the size and configuration of the cell is kept constant, by varying the amount of liquid held in the cell the level of the liquid/froth interface is changed, and therefore the depth of the froth (from the liquid/froth interface to the point at which the froth overflows from the cell) is changed. This embodiment is particularly preferable for use with existing flotation cells, as it requires no changes to the configuration of the cell itself.

The volume of liquid may be changed by changing the rate at which liquid is removed from the cell. If the rate is increased, the amount of liquid in the cell will decrease, increasing the froth depth. In contrast, decreasing the rate at which liquid is removed from the cell will increase the height of the liquid in the cell and therefore decrease the depth of the froth.

The volume of liquid may be changed by changing the rate at which liquid is supplied to the cell. If the rate is increased, the amount of liquid in the cell will increase, decreasing the froth depth. In contrast, decreasing the rate at which liquid is supplied to the cell will decrease the height of the liquid in the cell and therefore increase the depth of the froth.

In another embodiment the froth depth is controlled by changing the position of the overflow point in the cell. This could be achieved, for example, by a cell having a moveable rim or overflow weir at which the froth overflows, which can increase or decrease in height above the froth/liquid interface. Alternatively, the base of the cell could be movable with respect to the rim or weir. In either case, the froth depth would be changed by the change in total volume of the cell, as the volume of liquid is kept constant.

Preferably, controlling the froth depth is performed solely to increase gas recovery. That is, the present invention controls the froth depth for the purpose of increasing the gas recovery. Whilst existing methods of operating flotation cells may involve changing a froth depth, these changes are not for the purpose of optimising or increasing the gas recovery. Indeed, gas recovery has not been widely recognised as a variable which can be used in order to optimise the performance of flotation cells.

Preferably the step of controlling is performed by an automatic controller. That is, the control is preferably carried out automatically, allowing the optimisation to be performed efficiently. Prior art methods have relied on operator observations and experience to optimise flotation cell performance by manually inputting changes in operating conditions, whereas the present invention allows for measurement-driven control by an automated system.

In one embodiment, the froth depth is controlled using a control loop. This allows for feedback from the measured gas recovery to be used to control the froth depth, thereby allowing the system to find the optimum operation point, even without prior calibration.

Preferably, the step of controlling the gas recovery is performed whilst the flow rate at which gas is introduced into the liquid is kept substantially constant. By keeping the gas flow rate constant, the optimum froth depth at the set gas flow rate can be determined. This is preferable, as changing the gas flow rate may cause a change in the gas recovery.

Preferably, controlling includes at least one step of varying the froth depth. That is, the step of controlling the froth depth may comprise repeated steps of varying or changing the froth depth and then determining the gas recovery until it is determined that an optimum operating point has been reached. The optimum operating point may not be the precise point at which peak gas recovery is obtained, but may be an operating point within a predetermined range of the peak operating point in order to simplify the control operation. Further, varying the froth depth is performed whilst the flow rate at which gas is introduced into the liquid is kept substantially constant. This further simplifies the control operation.

Preferably, the method further comprises controlling the flow rate at which gas is introduced into the liquid to optimise the gas recovery with respect to the gas flow rate. The gas flow rate is another variable which affects the gas recovery from the cell and therefore the quality and amount of the froth obtained. According to the invention, both the gas flow rate and the froth depth may be optimised based on the measurement of the gas recovery, which is an easily quantifiable value.

Preferably the step of controlling the flow rate at which gas is introduced into the liquid is performed whilst the depth of the froth is kept substantially constant. This ensures that the optimum flow rate can be identified whilst discounting the effects of froth depth. It is recognised that changing the gas flow rate may affect the froth depth, due to a change in total volume of the bubble-containing liquid in the cell. However, any change in liquid/froth interface position will be relatively small compared to changes due to changing liquid flow rates into and out of the cell. Therefore the present application uses the phrase “whilst the depth of the froth is kept substantially constant” to refer to avoiding deliberate changes in froth depth, rather than those unavoidable changes introduced by changing the gas flow rate itself.

Preferably, the step of controlling the flow rate at which gas is introduced to the liquid is performed before the step of controlling the froth depth. According to the experimental data presented herein, this order of control steps would allow for the identification of the optimum operation point with respect to both the froth depth and the gas flow rate. In other systems, performing the steps in the opposite order could be preferable.

Preferably, the method further comprises: determining a parameter indicative of the gas recovery or of unrecovered gas; and controlling the froth depth in response to the determined parameter. The parameter may be a value, or a rate of change of the value, of the gas recovery or unrecovered gas or a parameter directly or indirectly related to one of those parameters (e.g. the bubble bursting rate). Further determining the parameter may comprise monitoring the overflow of froth from the cell and determining therefrom the gas recovery in the froth leaving the cell. That is, the invention may be put into practice by monitoring either the gas recovered in the froth or the gas which is not recovered or a parameter directly or indirectly related to one of those parameters, and escapes from the cell. For the purposes of control, it may be preferable not to monitor the actual value of the gas recovery (or gas lost) but a change in that value with time, for example. Such changes or rates may be particularly useful in systems using a feedback system for control.

Preferably determining the parameter further comprises monitoring the flow rate at which gas is introduced into the liquid. In order to determine the actual value of the gas recovery (or gas lost) it is necessary to know the amount of gas supplied to the cell. As the quantity could vary during operation, it is preferable to monitor the gas supply, to ensure accurate calculation of the parameter.

Some embodiments involve sampling froth behaviour in the cell and deriving the parameter from the sampling. This allows for the parameter to be derived for the entire cell based on a sample measurement. This can be convenient when monitoring the entire cell is difficult or expensive. Preferably sampling is carried out using a froth stability column. This allows for measurements to be performed on a portion of the cell, from which the overall behaviour of the cell can be inferred.

Preferably, determining the parameter further comprising using a detector to measure the speed at which froth overflows from the cell. For example, video cameras could be used to measure the speed of the overflowing froth. Optionally, the speed could then be used in conjunction with information about the height of the overflowing froth and the length of the overflow rim to calculate the gas recovery.

Preferably the liquid contains both desired matter to be recovered and undesired matter to be discarded, and the cell is operable to perform at least partial separation of the desired matter and undesired matter. Typically, one of either the undesired or desired matter is made hydrophobic, whilst the other is made hydrophilic, and separation is achieved by the preferential recovery of the hydrophilic material in the liquid and the hydrophobic material in the froth.

The liquid may include froth overflow from a froth flotation cell. That is, the cell being controlled may be a downstream cell which receives input liquid from froth overflowing from an upstream cell. Such arrangements are used for further refining the froth obtained from the upstream cell.

In a preferred embodiment, the liquid contains particles of an ore, and the ore contains minerals to be separated from the remainder of the ore. This allows valuable, metal carrying, minerals to be separated from other waste minerals (gangue).

The invention also provides a method of controlling operation of a bank of froth flotation cells including individually controlling cells according to any of the methods mentioned above.

Further, there is provided a method of controlling operation of a plant comprising a plurality of froth flotation cell banks including individually controlling banks according to the aforementioned method.

The invention also provides a method of operating a froth flotation cell including controlling operation of the cell according to any of the previously mentioned methods of controlling operation of a froth flotation cell.

Further, there is provided a method of operating a bank or plant comprising a plurality of froth flotation cells including controlling operation of the cells individually according to the aforementioned method of claim.

The invention also provides a method of obtaining a substance from a liquid containing two or more substances including adding said liquid to a froth flotation cell, operating the cell according to the method of either of the previous two methods, and obtaining the substance from the froth which overflows the cell during operation.

According to another aspect of the invention, there is provided a substance recovered from froth which overflows from a froth flotation cell, or liquid retained in the cell, wherein said froth flotation cell is controlled according to any previously mentioned method of controlling operation of a froth flotation cell.

According to another aspect of the invention, there is provided a method of designing a control program for operation of a froth flotation cell comprising: determining gas recovery for the cell in operation; determining a froth depth that increases gas recovery under at least one set of known operating conditions; and computing a froth depth to increase gas recovery. According to this method, a control program may be designed to optimise the gas recovery, thereby improving the performance of the flotation cell.

According to another aspect of the invention, there is provided a computer readable medium storing a set of instructions for implementing the design process according to the method of designing a control program.

There is also provided a computer readable medium for controlling a froth flotation cell according to the method of any one of the previously mentioned methods of controlling operation of a froth flotation cell.

According to another aspect of the invention, there is provided a froth flotation cell comprising: a gas inlet for introducing gas into a liquid in the cell and, in use, thereby creating a froth on the surface of the liquid, the froth having a depth from the surface of the liquid to an overflow point at which the froth overflows and leaves the cell; and a controller configured to control the gas recovery in the froth overflowing the cell to optimise the gas recovery with respect to the froth depth. This aspect provides for a controller to automatically adjust the performance of the flotation cell by controlling the froth depth.

According to another aspect of the invention, there is provided a control system for controlling a flotation cell, the control system comprising: means for determining the gas recovery in a froth overflowing the cell at an overflow point; and means for controlling the gas recovery to optimise the gas recovery with respect to a froth depth, the froth depth being from the surface of a liquid in the cell to the overflow point at which the froth overflows and leaves the cell.

In another embodiment, there is provided a froth flotation plant including a plurality of froth flotation cells as described above.

Embodiments of the invention will now be described, by way of example only, with reference to the Figures, in which:

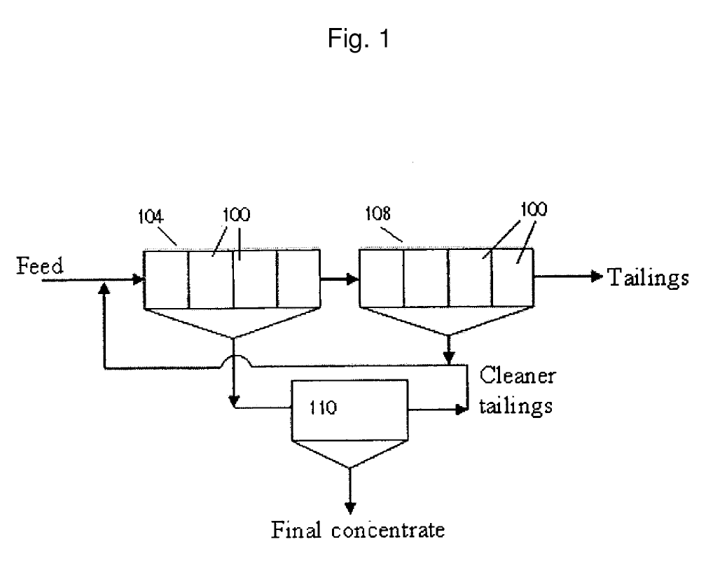

FIG. 1 shows a schematic view of an embodiment of a flotation circuit;

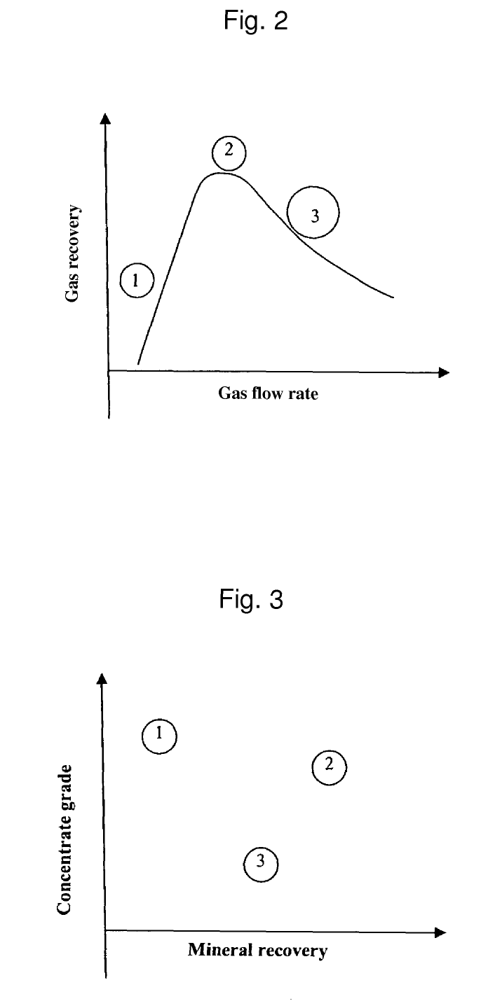

FIG. 2 shows a plot of gas recovery versus gas flow rate for a froth flotation cell;

FIG. 3 show a plot of concentrate grade versus mineral recovery at 3 different gas flow rates for a froth flotation cell;

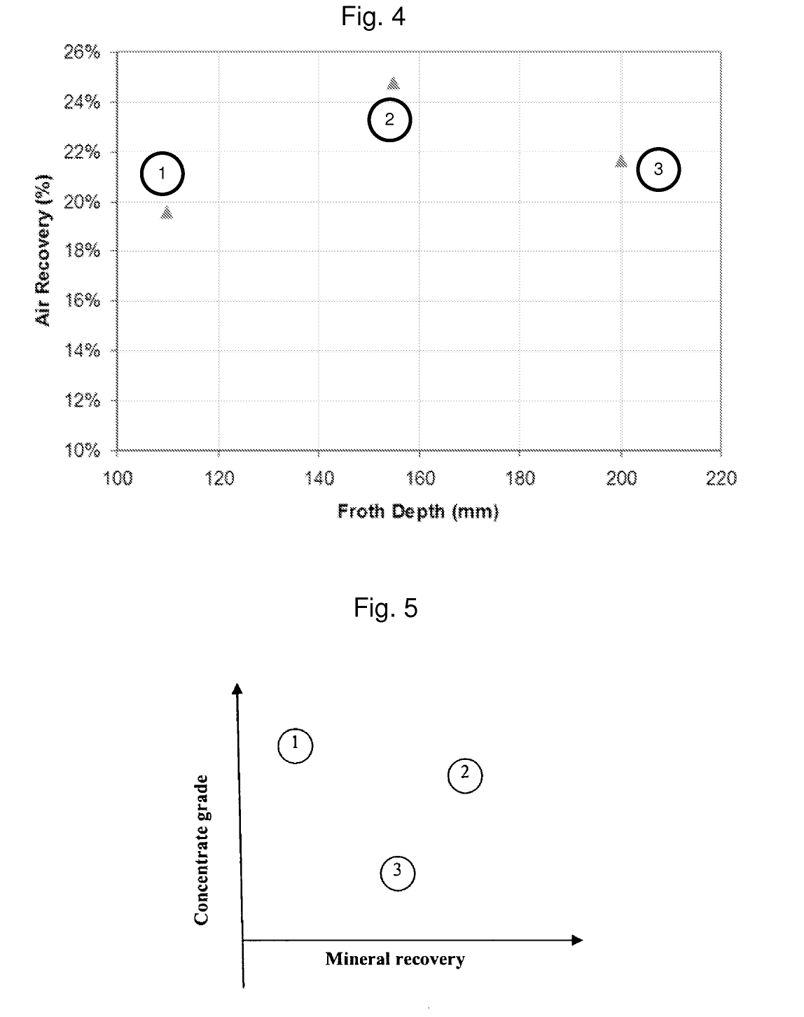

FIG. 4 shows a plot of gas recovery versus froth depth for experimental data from a froth flotation cell;

FIG. 5 show a plot of concentrate grade versus mineral recovery at 3 different froth depths for a froth flotation cell;

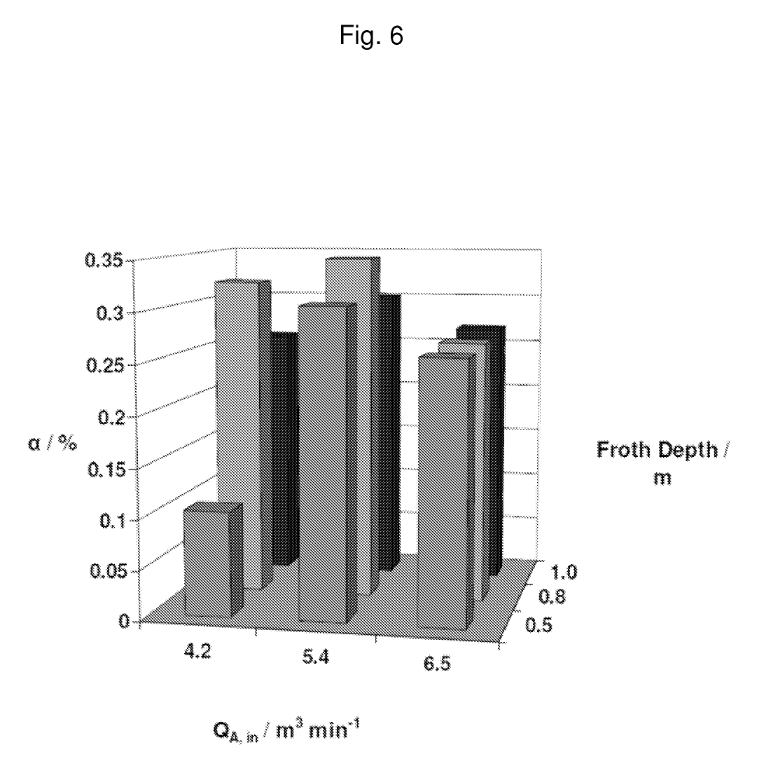

FIG. 6 shows experimental date relating gas recovery, gas flow rate and froth depth;

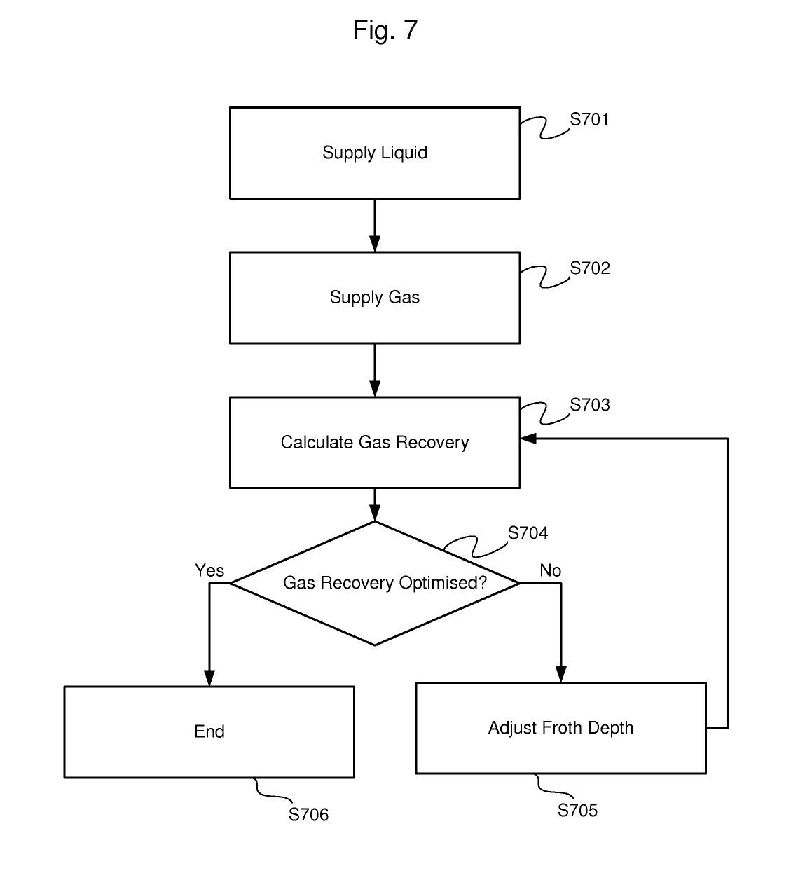

FIGS. 7 & 8 are flow charts indicating methods according to the present invention.

The present invention derives from a new understanding of the impact of the froth depth in a froth flotation cell on the valuable mineral recovery in the froth.

In the past, different trends have been observed with varying froth depths. However, the impact of other factors on the experiments meant no overall pattern could be discerned.

The present invention identifies that the gas recovery in the froth is a relatively easily quantified value, and that optimising the gas recovery in the froth leads to froths of both higher grade and having higher mineral recovery. In addition, there is an optimum froth depth, for a given set of other operating conditions. The other operating conditions include the inlet gas rate, the geometry of the flotation cell, the materials being separated and the chemical additives being used. The optimum froth depth produces a maximum value of the gas recovery in the froth. Therefore, varying the depth of the froth in a cell can be used to optimise the froth flotation process.

In overview, a method is provided for controlling operation of one or more froth flotation cells. In operation, air or other suitable flotation gas (including gas mixtures), such as nitrogen, is introduced into a froth flotation cell containing a liquid in order to create a froth. The liquid contains, for example, solid particles of an ore (including minerals containing valuable metal to be recovered). Overflow of the froth from the cell is then observed from which the gas recovery for the cell under the present operating conditions can be measured or inferred by appropriate method. The operation of the cell is controlled by varying the depth of the froth in the cell in order to optimise gas recovery.

Referring to FIG. 1, the apparatus is shown generally as a circuit having a number of banks or sub-banks, each including a plurality of froth flotation cells 100. It will be appreciated that the particular layout of the flotation circuit, the numbers of cells 100 that comprise each bank or sub-bank and the flow configuration of the various streams can vary widely. Each bank or sub-bank of cells may include any number or arrangement of cells 100, dependent on the practical conditions to be achieved. The cells 100 are connected to one another by any known means so that at least some of the contents of one cell 100 can be channeled into another cell 100. The practice of froth flotation and the design of such operations is known to the skilled person and is described in detail in, for example, Wills' Mineral Processing Technology, 7th edition (Wills, B. A. and Napier-Munn, T.).

A liquid containing two or more substances can be added to a froth flotation cell or cells 100 for separation, either wherein a desired substance is extracted from the froth which overflows the cell or wherein the froth includes undesired substances, so that a desired substance can be extracted from the pulp which remains in the cell after operation. In the context of the minerals industry, the substances are metal-containing minerals in an ore containing the minerals and gangue.

In the embodiment shown in FIG. 1 the flotation circuit includes a bank of rougher cells 104 into which a liquid feed typically water containing particles of ore, is introduced. Downstream from the rougher bank 104 there is provided a secondary rougher or “scavenger” bank 108 and a cleaner bank 110. Optionally, the circuit may include more than one rougher 104, scavenger 108 or cleaner 110 bank or sub-bank. In addition, both cleaners 110 and re-cleaners may be included. According to the embodiment as shown, both the cleaner 110 and the scavenger 108 include feedback channels for re-introducing material into the rougher 104 for additional processing.

In operation, ore from which a desired metal-containing mineral is to be separated and then extracted is crushed using any appropriate means. The crushed matter is then fed into a mill to be further broken down into a fine particle size, for example powder. The required particle size in any given situation will be dependent on a range of factors, including minerology, etc and can readily be determined. After milling, the particles are chemically treated in order to induce the appropriate wettability characteristics of the desired mineral which is to be separated and then extracted using the flotation process. According to a preferred embodiment, the particles are treated so that the surface of desired mineral is both hydrophobic and aerophilic. This ensures that the mineral will be strongly attracted to a gas interface such as a gas bubble and that air or other flotation gas will readily displace water at the surface of the desired mineral.

All undesired matter is preferably chemically treated so as to be hydrophilic. The methods for chemical treatment of the particles are well known and so are not discussed further herein.

In order to carry out a froth flotation process and separate and extract the desired mineral, the chemically treated particles are introduced into a cell 100 with water or other liquid. Bubbles of air or other gas are then introduced into the liquid (also referred to as a “slurry”, due to the presence of the solid particles) at a controlled rate via one or more gas inlets (not shown). Typically, the gas is supplied to the gas inlet or inlets of the cell 100 via a blower or other suitable apparatus. During this operation of the cell 100, the slurry at least partially separates so that at least some of the hydrophobic particles of desired mineral adhere to the gas bubbles whilst hydrophilic particles of undesired material and, dependent on conditions in the cell, some of the hydrophobic particles, will remain in the liquid.

The difference in density between the gas bubbles and the liquid dictates that the bubbles rise to the upper surface of the slurry in the cell 100, to create a froth thereon. The froth contains both bubbles and liquid which flows in the channels formed between the bubbles. The froth therefore contains both desired particles and undesired particles. In order for the desired particles to be extracted, conditions in the cell 100 are controlled so that at least some of the froth overflows from the cell 100. The froth that overflows or is removed from the cell 100 is either introduced into a further flotation cell 100 and/or forms a concentrate which includes the desired mineral to be recovered therefrom. Methods of concentrate recovery from froth and methods of extraction of valuable materials from such a concentrate will be well known such that further discussion of these is not provided.

In the embodiment shown in FIG. 1, once feed has been introduced into the rougher 104, the rougher 104 performs a froth flotation process as described above. The froth produced by the rougher 104 during that process is channeled into the cleaner 110 whilst the tailings from the rougher 104 are introduced into the scavenger 108. Both the scavenger 108 and the cleaner 110 then perform a froth flotation process as described. The froth produced by the scavenger 108 and the tailings produced by the cleaner are reintroduced into the rougher 104 for further processing. The tailings from the scavenger 108 are then discarded whilst the froth output from the cleaner 100 is harvested for extraction of the final concentrate as described above.

A range of variables and operational boundary conditions in the froth flotation cells 100 can be monitored and controlled in an attempt to achieve good recovery and good grade of the extracted concentrate.

As mentioned above, varying the gas flow rate to optimise gas recovery in the froth results in a froth having both a high concentrate grade and also high mineral recovery. The skilled person will appreciate that flotation froths are stabilised by the hydrophobic particles. The amount of particles which become loaded onto the bubbles is an important factor in the stability of the froth and will depend on the input gas flow rate. The peak in gas recovery is therefore due to the balance of loading on the bubbles to stabilise them (which generally decreases with increasing gas rate), and the flow velocity to the overflow lip of the flotation cell (which generally increases with increasing gas rate, until the gas recovery is too low because the bubbles burst too quickly).

Referring to the numbered points on FIG. 2, the relationship between gas recovery and gas flow rate is explained as follows:
1. At low gas flow rates the bubbles are heavily loaded as the ratio of hydrophobic particles to bubble surface area is relatively low. This prevents coalescence and bursting. Because the gas flow rate is low, in the froth the bubbles also travel slowly and therefore coalesce and burst due to the long time before they reach the overflow lip of the cell, resulting in a low gas recovery. Low gas flow rates may result in such heavy particle loads that the froth collapses under its own weight, also decreasing the gas recovery.
2. As gas flow rate to the cell is increased, particle loading on bubbles decreases, but remains high enough to stabilise the bubbles. The froth is now also flowing faster and bubbles reach the lip before they burst, resulting in an increased fraction of gas overflowing the weir (high gas recovery).
3. If gas flow rate is increased further, the particle-bubble ratio becomes very low, the particle load on the bubbles is low, reducing their stability and the bubbles rapidly burst (low gas recovery).

The relationship between gas recovery and gas rate can now be understood. As described above, flotation performance is a balance between concentrate recovery and concentrate grade. Each of these characteristic measurements is high when the performance of a flotation cell is at its peak. In operation of a flotation cell, the majority of desired solid particles enter the froth attached to bubbles. However, most detach and become entrained in the liquid flowing in channels between bubbles before reaching the lip of the cell. The undesired solids come into the froth by entrainment in the liquid flowing in channels between bubbles. The recovery of both entrained solids and those still attached to bubbles is therefore increased by more bubbles overflowing the lip, which is increased both by high gas rates and by high gas recovery.

As a result, the optimisation of performance of a flotation cell can be achieved due to an increase in extraction of desired solids as the gas recovery increases, balanced with a limited increase of entrained undesired solids because the gas flow rate is not significantly increased in the relevant operating range.

Referring to the numbered points in FIG. 3, which correspond to the gas flow rate and gas recovery points on FIG. 2, this relationship between optimal performance and gas recovery can be understood in more detail as follows:
1. At low gas flow rates there is a low desired mineral recovery due to the low gas recovery. A high grade is obtained due to low undesired solids entrainment as a result of low gas rates and low gas recovery.
2. As the gas flow rate to the cell is increased towards the peak in gas recovery, the mineral recovery increases as the flow of bubbles over the lip increases with an attendant high gas recovery. The concentrate grade decreases somewhat due to an increase in entrainment caused by higher gas rate and high gas recovery. This decrease is relatively small, since the gas flow rate is still low enough to limit the entrainment of undesired solids.
3. If gas flow rate is increased further past the peak in gas recovery, desired solids recovery slows as a result of the lower gas recovery. The concentrate grade also decreases, now significantly, because of the high gas rate causing a high degree of entrainment of undesired solids. Experimental tests have been employed by the applicant to investigate this theory and to show that switching from using known methods of controlling operation of froth flotation cells to using the present method increases both the grade and recovery of the concentrate retrieved, both on an individual cell basis and on a cumulative bank basis.

Gas recovery can be calculated from any one or more of the following measurements: the height of the froth overflowing a flotation cell, obtained for example by measuring the height of the tide mark on a scaled vertical surface perpendicular to the overflow lip; the velocity of the froth overflowing the cell, obtained via image analysis of a flotation cell in operation; the length or perimeter of the cell from which the froth overflows, known to the user from plant measurements; and the gas flow rate into the cell, which is controlled by the user.

As a result, gas recovery can be monitored, measured and controlled in a non-intrusive manner, without touching the froth or other contents of the flotation cell. The methods of image analysis to be used and the calculations involved will be known to the skilled person and may be found, for example, in Barbian referenced above. No further detail on this point is therefore provided. As an alternative to measuring gas recovery directly as described above, gas recovery can be derived or inferred using, for example, a froth stability column.

However, the invention has identified through experimental tests that, for a particular (i.e. constant) inlet gas flow rate, the froth depth also affects the gas recovery. Unexpectedly, the invention has identified that there is also a peak in gas recovery as the depth of the froth is varied. That is, if the same gas flow rate is provided to a cell with a different froth depth (but otherwise having the same operating conditions) the gas recovery is different, and as the froth height is varied from small to large, the gas recovery in the froth initially increases then reaches a peak and then decreases. Therefore, it is possible to optimise the gas recovery with respect to the froth depth to obtain an operating condition that provides an optimum compromise between mineral grade and mineral recovery. This is counter-intuitive, because it is usually expected that as the froth depth is increased, both gas recovery and mineral recovery will decrease. This is because, ultimately, the froth depth will become so deep that no froth will overflow from the cell—leading to a zero value of both the gas recovery and mineral recovery.

The counter intuitive result is shown in FIG. 4. FIG. 4 shows experimental data for a froth flotation cell, demonstrating how varying froth depth affects the air (gas) recovery at a constant air flow rate. As can be seen, the maximum gas recovery is obtained at the intermediate froth depth. FIG. 5 shows how varying the froth depth affects the mineral recovery and grade (with the numbered points in FIG. 5 corresponding the numbered points in FIG. 4). The froth depth providing the maximum gas recovery also gives the best trade-off between mineral recovery and grade.

This new method of optimising a froth flotation cell is particularly desirable for downstream froth flotation cells (e.g. for later ‘cleaners’), where it will be particularly desirable to optimise both the grade and mineral recovery. By increasing the grade without losing recovery, the volume of material that has to be treated downstream decreases, allowing greater residence times there, or smaller/less equipment.

FIG. 6 shows experimental results of how both froth depth and input air flow rate (Q_{A,in}) affect the air recovery (α) in the froth. As can be seen, this graph represents data collected for three different air flow rates (4.2, 5.4 and 6.5 m³ min⁻¹) and at three different froth depths (0.5, 0.8, 1.0 m). The air recovery (α) in the froth was measured for each combination of froth depth and inlet air flow rate.

As can be observed from FIG. 6, and would be expected from the discussion of FIG. 2, the gas (i.e. air) recovery (α) varies by increasing, to a peak value before decreasing again, as the flow rate is increased for any constant froth depth. In the present case, for each froth depth, the maximum gas recovery occurs at an inlet flow rate of 5.4 m³ min⁻¹. However, as can also be seen from FIG. 6 (and would be expected from FIG. 4), for any given gas inlet flow rate the gas recovery (α) also varies as the froth depth is changed. For the air flow rates of 4.2 and 5.4 m³ min⁻¹ a peak air recovery can be observed at a froth depth of 0.8 m.

For a flow rate of 6.5 m³ min⁻¹ a froth depth of 1.0 m results in the highest air recovery (although there is less variation than for the other flow rates). That is, the optimum froth depth is not constant for different gas flow rates.

Therefore, there is an optimum froth depth, for any given flow rate, which will provide the highest gas recovery (α).

In the case of FIG. 6, for any given starting froth depth, optimising the gas recovery with respect to the input flow rate, and then optimising the gas recovery with respect to the froth depth would allow the identification of the overall optimum operating point (occurring at an inlet gas flow rate of 5.4 m³ min⁻¹ and a froth depth of 0.8 m).

An increased froth depth provides a longer period of time for coalescence of bubbles to occur (as the bubbles in the froth have further to travel). It has also been observed in some systems that an increase in solids loading (i.e. the amount of particles held on the surface of the bubbles) occurs with increasing froth depth. This suggests that particles on films failing within the froth due to coalescence remain attached to bubbles in the froth (thereby increasing the overall loading of the froth). As increased solids loading would be expected to stabilise a froth, this would result in less overall coalescence and bursting, and therefore increase the overall gas recovery.

Therefore, one possible explanation of the “peak” profile is that at low froth depths, the dominant factor is that an increase in froth depth leads to an increase in gas recovery due to the stabilisation of the froth through higher solids loading. However, this effect would be in competition with the increased time for bubble coalescence as the froth depth increases. As such, at higher froth depth, bubble coalescence could be the dominating mechanism, so that further increasing the froth depth actually leads to a loss in recovery due to more bubble bursting. However, further experimentation is required to understand the underlying causes of the observed effects of varying the froth depth.

Nonetheless, the observed variations in gas recovery with froth depth provide another opportunity for optimising industrial froth flotation processes. In particular, by varying the froth depth the gas recovery can be optimised with respect to the froth depth, and the gas recovery has been shown to be a key parameter in optimising the overall grade and mineral recovery in the froth.

In this sense, “optimised with respect to the froth depth” means using a froth depth resulting in operation at or near the peak or maximum gas recovery attainable for a given set of operating conditions, such as gas flow rate. That is, because operating constraints mean it can be undesirable to control a process to operate exactly at the maximum gas recovery, ‘optimisation’ may lead to operation within a predetermined range around the maximum gas recovery. It is understood that changing the froth depth (for instance by changing the volume of liquid in the cell) may change other process variables. However, as will be understood from the previous discussion, in the context of the present application the term “optimised with respect to the froth depth” does not require all other variables to be kept exactly constant.

The method according to the embodiments of the present invention thus enables individual cells in a bank to be individually calibrated and/or controlled in order to optimise gas recovery and hence achieve optimum performance from that cell.

That is, according to the present invention, the gas recovery from a cell can be monitored, as the depth of froth in the cell is varied. The depth of the froth can be varied, either based on a feedback loop or lookup tables generated from a previous calibration, to provide an optimised gas recovery.

The depth of the froth may be varied by altering the flow of the liquid supplied to and removed from the cell. In practice, the first cell in a bank may receive the liquid at a set flow rate. In that case, the retained volume in the cell can be varied by adjusting the outlet flow rate. Changing the retained volume of liquid in the cell changes the available space for the froth and therefore changes the froth depth.

For subsequent cells in a bank, the input flow rate of the liquid will be dictated by the output from the previous cells. Therefore, when controlling an upstream cell to change the froth depth by changing the retained volume, it may be preferable to also adjust the output rates of the downstream cells to avoid changing the froth depths in those cells. This would be an example of an integrated control approach across multiple cells.

Alternatively, it may be preferable to control each individual cell separately. This would mean that each individual cell would be controlled to respond to the upstream perturbations. This would allow for each individual cell to be continuously monitored and optimised, irrespective of the upstream operations.

An alternative method of varying the froth depth is to design cells which have a variable overflow position. For example, the upper rim and/or weir of the cell could be designed to be extendable, thereby increasing the available space for the froth, without changing the volume of the liquid in the cell itself.

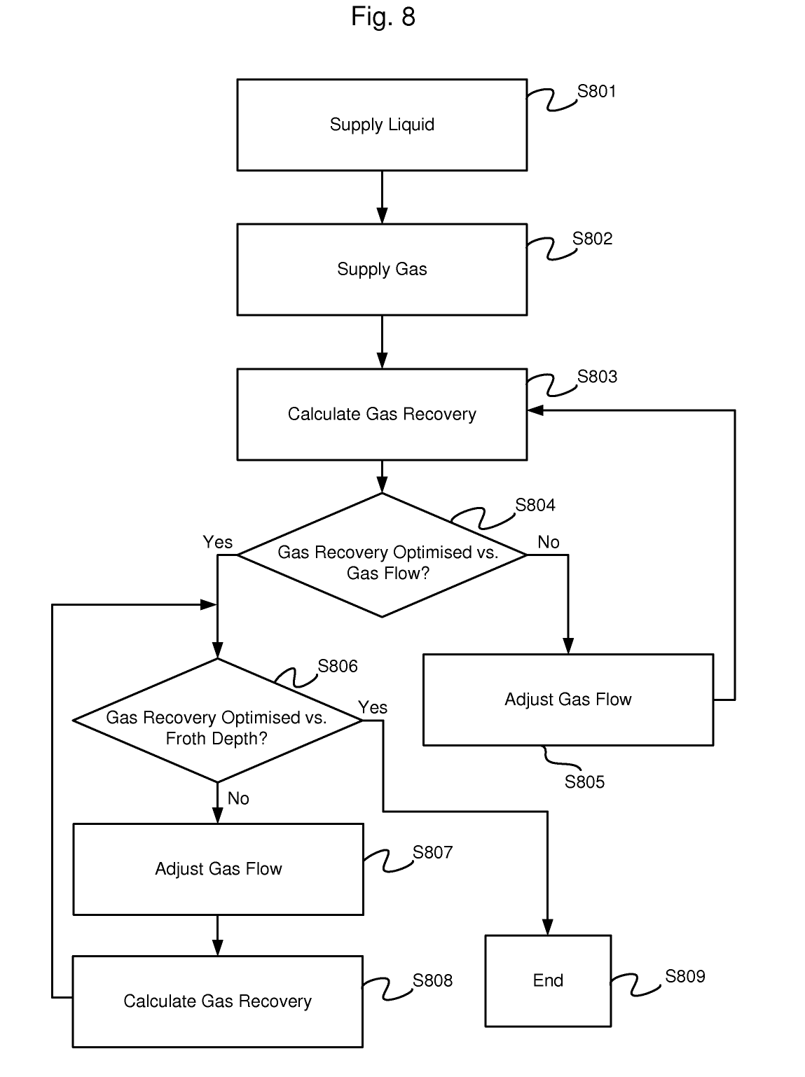

Methods of operating a froth flotation cell are now described with reference to FIGS. 7 and 8.

FIG. 7 shows a flow chart for operating a froth flotation cell and controlling the gas recovery in the froth.

At step S701, a liquid is supplied to a froth flotation cell. This liquid contains the substances to be separated, which may (for example) be particles of an ore that has previously been subjected to a comminution process. The liquid may also contain various additives in order to aid the separation.

At step S702, the liquid in the froth flotation cell is supplied with a gas. The gas is preferably supplied into the cell in the form of small bubbles, or the cell may contain shearing means to break up the incoming gas stream into bubbles. The gas may be a mixture of gases, such as air. As the gas rises through the liquid, hydrophobic particles attach to the bubble interface, and a froth is formed as the bubbles reach the surface of the liquid. The froth formed above the surface of the liquid extends to an overflow point in the cell, or weir for collecting the froth, via which the froth leaves the cell. That is, a froth depth is defined between the overflow point and the surface of the liquid. In practice, the froth will also contain some entrained liquid, and so contain both hydrophobic and hydrophilic particles.

At step S703, a parameter indicative of the gas recovery in the overflowing froth, with respect to the gas supplied to the cell, is calculated. This step (and subsequent steps S704 and S705) may be performed by an automatic controller. The parameter may be the value of the gas recovery itself, which may be a useful control value in the case when a full calibration has previously taken place. Alternatively, the parameter may be a change in the value of the parameter indicative of the gas recovery, which may be a more useful control value in the case of using a feedback loop.

As mentioned above, various processes for calculating parameters indicative of the gas recovery may be used. One option is to monitor the speed and height of the froth as it overflows at the overflow point and use these measurements (in combination with the dimensions of the overflow point or weir) to calculate the gas in the recovered froth. If the height of the overflowing froth is constant, it is only necessary to monitor the overflow speed of the froth. Either of these options provides a measurement for the cell as a whole. Alternatively, sampling measurements may be taken. One apparatus for performing such sampling is the froth stability column previously mentioned. Such methods provide a local measurement, which can then be scaled to infer a measurement across the entire cell.

In alternative embodiments, a parameter indicative of the unrecovered gas (that is, the gas supplied to the cell and leaves the cell without being incorporated into the overflowing froth) may be used instead of the parameter indicative of the recovered gas. Once again, the parameter may be a value of unrecovered gas or a change in the parameter indicative of unrecovered gas. The amount of unrecovered gas could be determined, for example, by collecting and measuring the gas evolved from the surface of the cell.

Other parameters that can be used include the “froth collapse rate”, being a measure of the time taken for a froth column to collapse by a defined amount when the gas supply is turned off. Alternatively, images of the froth (e.g. using spectral analysis) could be used to determine dynamic changes or sound sensors could be used to monitor bursting and coalescence events and to infer the gas recovery, and these would provide suitable parameters for use in the control.

At step S704, it is determined whether the gas recovery is optimised with respect to the froth depth. This determination could be performed based upon a previous calibration, and therefore by comparing the measured results to the previously obtained calibration results. Alternatively, the determination could be performed based upon a feedback loop, by comparing how previous froth depth variations have changed the gas recovery.

If it is determined at step S704 that the gas recovery is not optimised, then the method proceeds to step S705, at which the froth depth is adjusted. The value of the depth adjustment will depend upon the method of determining whether the gas recovery is optimised and the particular froth flotation system in question. For example, if a calibration has been performed, it may be possible to immediately adjust the froth depth to the optimum depth. Alternatively, if feedback is used, an incremental adjustment might be made.

For existing froth flotation cells, the most practical way of varying the froth depth may be to change the volume of retained liquid in the froth flotation cell. Reducing the amount of retained liquid will increase the space in the cell available for froth, whereas increasing the amount of retained liquid will reduce the space available for froth below the overflow point. The volume of the retained liquid in the froth flotation cell can be adjusted by changing the rate at which liquid is supplied to or withdrawn from the cell.

An alternative way to adjust the depth of the froth is to use a froth flotation cell which has been designed to have an overflow point with a variable position. For example, the rim of the cell or weir at which the froth overflows could be adjustable to increase or decrease its height above the surface of the liquid in the cell. That is, the walls of the cell and/or weir could be constructed to have an adjustable height (e.g. through the use of telescopically adjustable sections), or the position of the base of the cell could be adjustable with respect to the upper rim/overflow point.

After the froth depth has been adjusted, and a suitable delay to allow for the system to adjust, the method returns to step S703 at which the gas recovery is re-calculated, and then step S704 where it is determined by whether the gas recovery has been optimised. Preferably, the change in froth depth will increase the gas recovery, even if the gas recovery is not optimised. However, the skilled person will understand that a feedback control loop could result in the froth depth corresponding to the maximum gas recovery being ‘overshot’ during the depth adjustment, possibly resulting in a decrease in gas recovery.

If it is determined that the gas recovery has been optimised at step S704, then the control method comes to an end at step S706.

As mentioned above, it may be desirable to optimise both the gas flow rate and the froth depth with respect to the gas recovery in the froth. FIG. 8 is a flow chart showing one such possible control method.

At steps S801 and S802, (corresponding to steps S701 and S702) a liquid and gas are supplied to the froth flotation cell. The gas recovery in the froth overflowing the cell is calculated at step S803, in the same way as discussed for step S703.

In step S804 it is determined whether the gas recovery in the froth has been optimised with respect to the flow rate of the gas supplied into the cell. As previously discussed for step S704, this determination may be made based upon a previous calibration, or on a feedback loop.

If it is determined that the gas flow rate has not been optimised, the method moves to step S805, at which the gas flow rate is adjusted. The flow rate of gas into the cell may be adjusted, for example, by controlling a valve to increase or decrease the amount of gas entering the cell.

After the gas flow rate has been adjusted, and after a suitable period of time to allow the system to respond, the method returns to steps S803 and S804 at which the gas recovery in the froth is calculated and it is determined whether the gas recovery has been optimised with respect to the gas flow rate.

When it has been determined that the gas recovery has been optimised with respect to the gas flow rate, the method moves to step S806 at which it is determined whether the gas recovery has been optimised with respect to the froth depth. As discussed with respect to step S704, this determination may be based upon a previous calibration or a feedback loop.

If it is determined that the gas recovery has not been optimised with respect to the froth depth, the method moves to step S807 at which the froth depth is adjusted, as discussed with respect to step S706. After the froth depth has been adjusted and a suitable period of time has passed to allow the system to respond, the method moves to step S808 at which the gas recovery is calculated (as discussed with respect to step S803). The method then returns to step S806 to determine whether the gas recovery has been optimised with respect to the froth depth. If it is determined that the gas recovery has been optimised with respect to the froth depth, the method moves to step S809 at which the control method comes to an end.

In an alternative embodiment, the method of FIG. 6, instead of coming to an end at step S809, returns to step S804 to determine whether the gas recovery is still optimised with respect to the gas flow rate. That is, because the gas flow rate was originally optimised for a particular froth depth, and the froth depth may have been changed in steps S806-S808, it may be desirable to repeat the optimisation process for both the gas flow rate and the froth depth.

In other embodiments, the steps of the optimisation with respect to the froth depth and the optimisation with respect to the gas flow rate could occur in parallel, rather than consecutively. This is possible when the response time of the flotation cell to a change in gas flow rate is significantly different to the response time to a change in froth depth. For example, the response of the cell to a change in froth depth might be slow (as changing the froth depth could be relatively slow if it involves draining or filling a cell), whereas the gas flow rate could be changed relatively quickly (by opening or closing a valve). In that case, it may be possible to find an optimum gas flow rate for each incremental change in froth depth, thereby ensuring (instantaneously, as opposed to long term) optimised grade and mineral recovery even when the froth depth is being changed.

In a further alternative embodiment, it may be desirable to optimise the gas recovery with respect to the froth depth before optimising the gas recovery with respect to the gas flow rate.

It will be appreciated that in a preferred embodiment the operation of each flotation cell in a bank, plant or other circuit of cells will be optimised using gas recovery maximisation, however it is possible to maximise gas recovery for any number of cells within a circuit in order to improve cumulative grade and recovery of the concentrate extracted therefrom.

By using gas recovery as the control parameter, the method enables an increased amount of desired solids to be extracted from particles or other matter which is fed into a flotation cell, whilst at the same time limiting the amount of undesired solids extracted from the cell. By using this approach of minimising the amount of undesired material extracted, the method achieves enhanced performance with respect to both grade and recovery of desired solid, as compared to known processes which concentrate on achieving high proportions of desired material and as a result only optimise at best one or other of grade and recovery.

The method according to embodiments of the present invention is straightforward to carry out as it only uses measurements and measurements which can be obtained from image analysis of a flotation cell in operation. No complicated calculations are required in order to calibrate the flotation cells. As a result, the method can be used for troubleshooting and as an optimisation tool for flotation performance improvement. There is also potential for use in closed loop control. Furthermore, gas recovery tests as described can be used as a quick and reliable method for designing an experimental program.

A control program can be designed in order to control the operation of a plant or bank of froth flotation cells according to the method described above. In particular, a computer-implementable program can be designed for controlling operation of a plant or bank of froth flotation cells, wherein the gas flow rate into each individual cell is varied in order to achieve optimal gas recovery from that cell throughout operation, under any given operating conditions. It is also possible to determine the solution which achieves this control for a particular plant or bank for one or more predetermined sets of operating conditions, and to record this solution on a computer readable medium, for execution at the plant or bank.

The above described methods have been directed mainly to extracting mineral from ore however it will be appreciated that the control and calibration methods can be used in any froth flotation process. Examples include de-inking of paper, wherein it is the undesired ink which is removed via the froth, and the desired paper that remains in the pulp in the flotation cell. The present method can also be used for calibration and control of froth flotation cells for protein separation, molecular separation and waste separation.

1. A method of controlling operation of a froth flotation cell, the method comprising:
introducing gas into a liquid in the cell, thereby to create a froth on the surface of the liquid, the froth having a depth from the surface of the liquid to an overflow point at which the froth overflows and leaves the cell; and
controlling the froth depth to optimise the gas recovery with respect to the froth depth.

2. The method according to claim 1, wherein the froth depth is controlled by changing the volume of liquid in the cell.

3. The method of claim 2, wherein the volume of liquid is changed by changing the rate at which liquid is removed from the cell.

4. The method according to claim 2, wherein the volume of liquid is changed by changing the rate at which liquid is supplied to the cell.

5. The method according to claim 1, wherein the froth depth is controlled by changing the position of the overflow point in the cell.

6. The method according to claim 1, comprising controlling the froth depth solely to increase gas recovery.

7. The method according to claim 1, wherein the step of controlling is performed by an automatic controller.

8. The method according to claim 1, wherein the froth depth is controlled using a control loop.

9. The method according to claim 1, wherein the step of controlling the gas recovery is performed whilst the flow rate at which gas is introduced into the liquid is kept substantially constant.

10. The method according to claim 1, wherein controlling includes at least one step of varying the froth depth.

11. The method according to claim 10, wherein varying the froth depth is performed whilst the flow rate at which gas is introduced into the liquid is kept substantially constant.

12. The method according to claim 1, further comprising controlling the flow rate at which gas is introduced into the liquid to optimise the gas recovery with respect to the gas flow rate.

13. The method according to claim 10, wherein the step of controlling the flow rate at which gas is introduced into the liquid is performed whilst the depth of the froth is kept substantially constant.

14. The method according to claim 12, wherein the step of controlling the flow rate at which gas is introduced to the liquid is performed before the step of controlling the froth depth.

15. The method according to claim 1, further comprising:
determining a parameter indicative of the gas recovery or of unrecovered gas; and
controlling the froth depth in response to the determined parameter.

16. The method according to claim 15, wherein the parameter is a value, or a rate of change of the value, of the gas recovery or unrecovered gas.

17. The method according to claim 15, wherein determining the parameter comprises monitoring the overflow of froth from the cell and determining therefrom the gas recovery in the froth leaving the cell.

18. The method according to claim 17, wherein determining the parameter further comprises monitoring the flow rate at which gas is introduced into the liquid.

19. The method according to claim 1, comprising sampling froth behaviour in the cell and deriving the parameter from the sampling.

20. The method according to claim 19, in which sampling is carried out using a froth stability column.

21. The method according to claim 1, wherein determining the parameter further comprising using a detector to measure the speed at which froth overflows from the cell.

22. The method according to claim 1, wherein the liquid contains both desired matter to be recovered and undesired matter to be discarded, wherein the cell is operable to perform at least partial separation of the desired matter and undesired matter.

23. The method according to claim 1, wherein the liquid includes froth overflow from a froth flotation cell.

24. The method according to claim 1, wherein the liquid contains particles of an ore, and the ore contains minerals to be separated from the remainder of the ore.

25. A method of controlling operation of a bank of froth flotation cells including individually controlling cells according to the method of claim 1.

26. A method of controlling operation of a plant comprising a plurality of froth flotation cell banks including individually controlling banks according to the method of claim 25.

27. A method of operating a froth flotation cell including controlling operation of the cell according to the method of claim 1.

28. A method of operating a bank or plant comprising a plurality of froth flotation cells including controlling operation of the cells individually according to the method of claim 27.

29. A method of obtaining a substance from a liquid containing two or more substances including adding said liquid to a froth flotation cell, operating the cell according to the method of claim 27, and obtaining the substance from the froth which overflows the cell during operation.

30. A method of obtaining a substance from a liquid containing two or more substances including adding said liquid to a froth flotation cell, bank or plant, operating the cell, bank or plant according to the method of claim 27, and obtaining the substance from the matter which remains in the froth flotation cell, bank or plant after operation.

31. A method of obtaining a refined ore, the method comprising a method according to claim 30.

32. A substance recovered from froth which overflows from a froth flotation cell, or liquid retained in the cell, wherein said froth flotation cell is controlled according to the method of claim 1.

33. A method of designing a control program for operation of a froth flotation cell comprising: determining gas recovery for the cell in operation; determining a froth depth that increases gas recovery under at least one set of known operating conditions; and computing a froth depth to increase gas recovery.

34. A computer readable medium storing a set of instructions for implementing the design process according to the method of claim 33.

35. A computer readable medium for controlling a froth flotation cell according to the method of claim 1.

36. A froth flotation cell comprising:
a gas inlet for introducing gas into a liquid in the cell and, in use, thereby creating a froth on the surface of the liquid, the froth having a depth from the surface of the liquid to an overflow point at which the froth overflows and leaves the cell;
and a controller configured to control the gas recovery in the froth overflowing the cell to optimise the gas recovery with respect to the froth depth.

37. A froth flotation plant including a plurality of froth flotation cells as claimed in claim 36.

38. A control system for controlling a flotation cell, the control system comprising:
means for determining the gas recovery in a froth overflowing the cell at an overflow point; and
means for controlling the gas recovery to optimise the gas recovery with respect to a froth depth, the froth depth being from the surface of a liquid in the cell to the overflow point at which the froth overflows and leaves the cell.
